(19) United States
(12) Patent Application Publication
(10) Pub. No.: US 2026/0115928 A1
(43) Pub. Date: Apr. 30, 2026

(54) CONTAINER CONTROL METHOD, ELECTRONIC DEVICE AND STORAGE MEDIUM

(71) Applicant: MEITUAN TECHNOLOGY CO., LTD., Shenzhen (CN)

(72) Inventors: Xu ZHANG, Shenzhen (CN); Zhihao WANG, Shenzhen (CN); Baoxu LIU, Shenzhen (CN)

(73) Assignee: MEITUAN TECHNOLOGY CO., LTD., Shenzhen (CN)

(21) Appl. No.: 19/292,636

(22) Filed: Aug. 6, 2025

(30) Foreign Application Priority Data
Oct. 30, 2024 (CN) 202411538904.X

(51) Int. Cl. B25J 9/16; B25J 13/08; B65G 1/04; G06T 7/73; G06T 7/80

(52) U.S. Cl. CPC B25J 9/1697; B25J 13/089; B65G 1/04; G06T 7/74; G06T 7/80; B65G 2203/0216; B65G 2203/041; G06T 2207/10032; G06T 2207/30168; G06T 2207/30244; G06T 2207/30252

(57) ABSTRACT

A container control method, where a movable robotic arm is arranged in the container, and a visual component and an end effector located at an end of the robotic arm are arranged on the robotic arm. The container control method includes: obtaining a target photographing pose by calibrating, in response to acquiring a handover instruction for target goods, a photographing pose of the robotic arm according to a target handover position indicated by the handover instruction; collecting a first image of a first position identifier by the visual component after controlling the robotic arm to move to the target photographing pose; and controlling, according to the first image, the robotic arm to perform handover operation on the target goods by the end effector.

### CROSS-REFERENCE TO RELATED APPLICATION

The present application claims the benefit of priority to Chinese Application No. 202411538904.X, filed on Oct. 30, 2024, the contents of which are incorporated herein by reference in their entirety for all purposes.

### BACKGROUND OF THE INVENTION

Performing handover operation on goods refers to receiving the goods and transferring the goods to a specified position. Before handover operation is performed, spatial positioning needs to be performed on a goods handover position based on a visual spatial positioning technology, so as to implement accurate handover operation on the goods based on a positioning result.

### SUMMARY OF THE INVENTION

The present disclosure relates to the technical field of goods handling, and in particular, to a container control method, an electronic device, and a storage medium.

According to a first aspect, the present disclosure provides a container control method, where the container includes a movable robotic arm, and a visual component and an end effector located at an end of the robotic arm are arranged on the robotic arm. The method includes:
obtaining a target photographing pose by calibrating, in response to acquiring a handover instruction for target goods, a photographing pose of the robotic arm according to a target handover position indicated by the handover instruction, where the target photographing pose is a photographing pose at which the robotic arm photographs a first position identifier by the visual component, the first position identifier is used for identifying the target handover position, and the target handover position is a handover position of the target goods;
collecting a first image of the first position identifier by the visual component after controlling the robotic arm to move to the target photographing pose; and
controlling, according to the first image, the robotic arm to perform handover operation on the target goods by the end effector.

According to a second aspect, the present disclosure provides a container control apparatus, where a movable robotic arm is arranged in the container, and a visual component and an end effector located at an end of the robotic arm are arranged on the robotic arm. The apparatus includes:
a calibration module, configured to obtain a target photographing pose by calibrating, in response to acquiring a handover instruction for target goods, a photographing pose of the robotic arm according to a target handover position indicated by the handover instruction, where the target photographing pose is a photographing pose at which the robotic arm photographs a first position identifier by the visual component, the first position identifier is used for identifying the target handover position, and the target handover position is a handover position of the target goods;
   an image collection module, configured to collect a first image of the first position identifier by the visual component after controlling the robotic arm to move to the target photographing pose; and
   a control module, configured to control, according to the first image, the robotic arm to perform handover operation on the target goods by the end effector.

According to a third aspect, the present disclosure provides a non-transitory computer-readable storage medium, configured to store a computer program, where the computer program, when executed by one or more processors of an electronic device, causes the electronic device to perform steps of the container control method described in the first aspect of the present disclosure.

According to a fourth aspect, the present disclosure provides an electronic device, including:
a memory, having a computer program stored therein; and
one or more processors, are collectively configured to execute the computer program in the memory, to cause the electronic device to perform steps of the container control method described in the first aspect of the present disclosure.

According to a fifth aspect, the present disclosure provides a computer program product, including a computer program, where the computer program, when executed by one or more processors of an electronic device, causes the electronic device to perform steps of the container control method described in the first aspect of the present disclosure.

### BRIEF DESCRIPTION OF DRAWINGS

The accompanying drawings are intended to provide further understanding of the present disclosure and constitute a part of this specification. The accompanying drawings and the specific embodiments below are used together for explaining the present disclosure rather than constituting a limitation to the present disclosure. In the figures:

FIG. 1 is a schematic structural diagram of a robotic arm mounted inside a container.

FIG. 2 is a flowchart of a container control method according to an example.

FIG. 3 is a flowchart of a container control method according to the embodiment shown in FIG. 2.

FIG. 4 is a flowchart of a container control method according to the embodiment shown in FIG. 2.

FIG. 5 is a flowchart of a container control method according to the embodiment shown in FIG. 2.

FIG. 6 is a block diagram of a container control apparatus according to an example.

FIG. 7 is a block diagram of a container control apparatus according to the embodiment shown in FIG. 6.

FIG. 8 is a block diagram of an electronic device according to an example.

### DETAILED DESCRIPTION OF THE INVENTION

Specific embodiments of the present disclosure are described in detail below with reference to the accompanying drawings. It is to be understood that the specific embodiments described herein are merely used to describe and explain the present disclosure, but are not intended to limit the present disclosure.

It is to be noted that in the present disclosure, all actions of acquiring a signal, information, or data are performed under the premise of compliance with the corresponding data protection regulations and policies of relevant countries, as well as authorization from the owner of the corresponding apparatus.

In the process of performing spatial positioning on the goods handover position based on the visual spatial positioning technology, a visual component needs to be used to collect an image of a preset recognition beacon, and spatial visual positioning on the goods handover position is implemented based on the image. In the related art, the positioning precision of spatial visual positioning performed based on the image of the preset recognition beacon needs to be improved, consequently affecting the accuracy of goods handover operation.

First, an application scenario of the present disclosure is described. The present disclosure is mainly applied to a scenario of controlling a container (such as a parcel locker or a takeout locker) equipped with a robotic arm. The robotic arm is movably installed inside a container body. The robotic arm may control goods to move between different storage compartments in the container, and may also control the goods to be handed over between a carrier and the container. It is to be understood that the carrier may be various types of goods delivery devices such as an unmanned aerial vehicle, an unmanned vehicle, and a robot. For ease of description, the present disclosure primarily describes a delivery scenario of the unmanned aerial vehicle as an example.

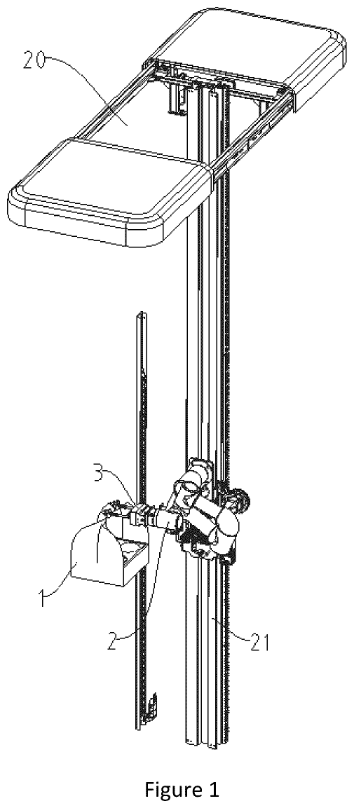

FIG. 1 is a schematic structural diagram of a robotic arm mounted inside a container. As shown in FIG. 1, a track 21 is arranged in the container (not shown in the figure), and a robotic arm 2 may move up and down on the track 21. When the robotic arm 2 moves up and down, an end effector 3 of the robotic arm 2 may also be driven to move up and down. For example, the robotic arm 2 may be controlled to move upward on the track 21 to drive the end effector 3 and goods 1 hung on the end effector 3 to move to a top opening 20, so that the end effector 3 is placed at the top opening 20 to perform handover operation of the goods 1 with a flying unmanned aerial vehicle. In addition, the robotic arm 2 is further provided with a visual component (which is not shown in the figure, and may be arranged above the end effector 3). The visual component is configured to collect an image of a position identifier located at a goods handover position. The position identifier may be a visual recognition beacon (for example, a two-dimensional code). The goods handover position is a position at which goods handover operation needs to be performed, for example, a position of a mounting mechanism arranged in each storage compartment of the container (or arranged on the unmanned aerial vehicle). Then, after spatial visual positioning is performed based on the image, position information of the goods handover position is recognized, and then a moving pose of the robotic arm 2 is controlled to be adjusted according to the position information, so as to adjust a relative position between the end effector 3 and the goods handover position, thereby ensuring that the goods 1 can be successfully handed over. It is to be understood that for ground delivery devices such as an unmanned vehicle or a robot, the opening 20 is correspondingly located at a side face or bottom of the container.

In the above process, before the visual component is used to collect the image of the position identifier located at the goods handover position, the robotic arm needs to be controlled to move to a preset photographing pose corresponding to the goods handover position, so that at the preset photographing pose, a higher-quality image of the visual recognition beacon can be collected based on extrinsic parameters of the visual component. In the related art, the image of the position identifier is usually collected at a fixed photographing pose. However, with the passage of time, a position of the visual recognition beacon may move, and positioning precision of spatial visual positioning performed based on a beacon image collected at the fixed pose needs to be improved, consequently affecting accuracy of the goods handover operation.

To resolve the above existing problem, the present disclosure provides a container control method and apparatus, a storage medium, an electronic device, and a program product. Specific embodiments of the present disclosure will be described in detail below in conjunction with the accompanying drawings.

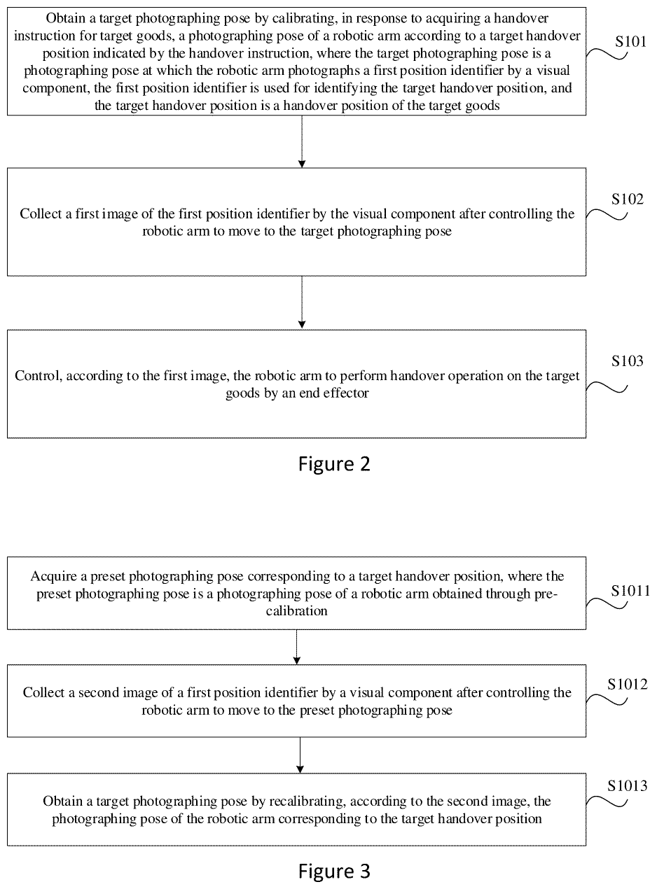

FIG. 2 is a flowchart of a container control method according to an example. The method may be applied to a container, or may be applied to a server. If the container control method is applied to the server, the container may communicate with the server, so that the server controls the container after issuing a control instruction to the container.

A movable robotic arm 2 shown in FIG. 1 is arranged inside the container in the present disclosure. A visual component and an end effector 3 located at an end of the robotic arm are arranged on the robotic arm 2. The movable robotic arm herein means that the robotic arm moves up and down in a vertical direction and can perform spatial motion with multiple degrees of freedom after moving to a certain height in the vertical direction. For example, the robotic arm may be a six-degree-of-freedom robotic arm, having six independent driving joints, and each driving joint may move independently, thereby implementing a complex spatial motion. In an actual application scenario, a Rail Guided Vehicle (RGV) may be controlled to move on a track in the container so as to drive the robotic arm to move up and down in a direction of the track, and then at least one driving joint of the robotic arm is controlled to move, thereby implementing a more complex spatial motion.

The pose of the robotic arm is changed by controlling at least one driving joint of the robotic arm to move. As the pose of the robotic arm changes, the pose of the visual component on the robotic arm also changes. For the visual component having different poses, extrinsic parameters of the visual component are also different. In addition, the container may include multiple storage compartments. The multiple storage compartments may further include buffer compartments and common compartments. A user may open the common compartment to take goods from the common compartment. The buffer compartment is used for buffering the goods when there is no unoccupied common compartment, and transferring the goods in the buffer compartment to the common compartment in response to determining that there is a common compartment in an idle state.

As shown in FIG. 2, the container control method includes the following steps:

Step S101: Obtain a target photographing pose by calibrating, in response to acquiring a handover instruction for target goods, a photographing pose of the robotic arm according to a target handover position indicated by the handover instruction, where the target photographing pose is a photographing pose at which the robotic arm photographs a first position identifier by the visual component, the first position identifier is used for identifying the target handover position, and the target handover position is a handover position of the target goods.

The target goods may include goods such as takeout packages and express items. The handover instruction may include a first instruction for mounting the target goods from the end effector to a target mounting mechanism, or a second instruction for transferring the target goods from the target mounting mechanism to the end effector. The target mounting mechanism is a mounting mechanism arranged in a target storage compartment (a storage compartment in which the target goods are already stored or the target goods are to be stored) or a mounting mechanism arranged on the unmanned aerial vehicle (for example, the mounting mechanism may be a clamping jaw or a hook where the goods can be mounted). The mounting mechanism may be configured to carry the goods. The unmanned aerial vehicle is configured to transport the target goods.

The following describes a triggering scenario of acquiring the handover instruction for the target goods.

The container control method provided in the present disclosure may relate to the following three goods delivery scenarios. The target goods are delivered from the unmanned aerial vehicle to the container (for example, the unmanned aerial vehicle places a takeout package into a takeout locker, so that the user can take food, the target goods are transferred from the container to the unmanned aerial vehicle (for example, after a merchant places a takeout package into a takeout locker, the unmanned aerial vehicle delivers the takeout package to the user after taking food from the takeout locker), and the target goods are transferred from one storage compartment in a container body to another storage compartment (for example, the takeout package is transferred from the buffer compartment in the container to the common compartment). In each of the above three goods delivery scenarios, when the robotic arm configured in the container is used to perform goods transfer, the target goods need to be mounted from the end effector to the target mounting mechanism and/or the target goods need to be transferred from the target mounting mechanism to the end effector.

For example, in the process of delivering the target goods from the unmanned aerial vehicle to the container, the unmanned aerial vehicle lands to a takeoff and landing platform at a top of the container. The takeoff and landing platform is provided with a push rod that may push the unmanned aerial vehicle upright. The unmanned aerial vehicle may send a goods delivery notification message to the container. In response to receiving the goods delivery notification message, the container controls a top cover at the top to be opened and controls the RGV to move to a preset exterior waiting position, so that the robotic arm also moves to the preset exterior waiting position to initiate goods receiving preparation. Then, the container may generate a second instruction for the target goods and send the second instruction to the unmanned aerial vehicle. The second instruction is used for instructing to transfer the target goods from the target mounting mechanism on the unmanned aerial vehicle to the end effector of the robotic arm. In addition, the second instruction further instructs that a target handover position for this goods handover operation may be a position where the target mounting mechanism of the unmanned aerial vehicle is located. Then, steps S101 to S103 may be performed to implement the handover operation of transferring the target goods from the target mounting mechanism of the unmanned aerial vehicle to the end effector of the robotic arm. Next, the container may determine any vacant storage compartment (which may be the buffer compartment, or the common compartment) from the multiple storage compartments as the target storage compartment, and generate a first instruction after controlling the RGV to move to a height of the target storage compartment. The first instruction is used for instructing to mount the target goods from the end effector of the robotic arm to the target mounting mechanism in the target storage compartment. The first instruction further instructs that a target handover position of this goods handover operation may be a position of the target mounting mechanism in the target storage compartment. Then, steps S101 to S103 may be performed to implement the handover operation of mounting the target goods from the end effector of the robotic arm to the target mounting mechanism in the target storage compartment. Therefore, the process of delivering the target goods from the unmanned aerial vehicle to the container includes two handover operations on the target goods.

It is to be further noted that after the target goods are delivered from the unmanned aerial vehicle to the container, the container may send a delivery completion notification message to the server and/or the unmanned aerial vehicle. In this case, the unmanned aerial vehicle may take off, and then the server may schedule another delivery task for the unmanned aerial vehicle. After the target goods are delivered from the unmanned aerial vehicle to the container, the container may further control the RGV to move to a preset interior waiting position, so that the RGV may wait for scheduling of a next delivery task at the preset interior waiting position. In another possible application scenario, after the target goods are delivered from the unmanned aerial vehicle to the container, the RGV may continue to stay at a track height corresponding to the position of the target storage compartment, so as to wait for next task scheduling.

The above describes two handover instructions in the process of delivering the target goods from the unmanned aerial vehicle to the container and the process of performing handover of the target goods in response to each handover instruction. The process of transferring the target goods from the container to the unmanned aerial vehicle by the robotic arm sequentially includes two sub-processes: transferring the target goods from the target mounting mechanism in the target storage compartment of the container to the end effector of the robotic arm (corresponding to the second instruction), and mounting the target goods from the end effector of the robotic arm to the target mounting mechanism of the unmanned aerial vehicle (corresponding to the first instruction). The process of transferring the target goods from a storage compartment in a container body to another storage compartment by the robotic arm sequentially includes two sub-processes: transferring the target goods from the target mounting mechanism in a first storage compartment of the container to the end effector of the robotic arm (corresponding to the second instruction), and mounting the target goods from the end effector of the robotic arm to the target mounting mechanism of a second storage compartment (corresponding to the first instruction).

That is, in all of the above three goods delivery scenarios, the container may be triggered to acquire the first instruction for mounting the target goods from the end effector to the target mounting mechanism and the second instruction for transferring the target goods from the target mounting mechanism to the end effector.

In addition, the robotic arm in the present disclosure is further provided with the visual component. As the pose of the robotic arm changes, the pose (which may be understood as the extrinsic parameter of the visual component) of the visual component on the robotic arm also changes. Image content collected by the visual component at different poses is also different. Therefore, to accurately collect the image of the first position identifier located at the target handover position, the pose of the visual component needs to be calibrated first. The photographing pose of the robotic arm is a photographing pose at which the first position identifier is photographed by the visual component on the robotic arm. In the present disclosure, the pose of the robotic arm is controlled to change to adjust the pose of the visual component. Therefore, to adjust the pose of the visual component, the photographing pose of the robotic arm may be calibrated to obtain the target photographing pose. Then, after the robotic arm is controlled to move to the target photographing pose, the visual component on the robotic arm is also in an optimal photographing pose.

The first position identifier includes a visual recognition beacon (for example, a two-dimensional code) corresponding to the target handover position. For example, the first position identifier may be arranged at the target storage compartment, so as to perform spatial positioning on the position of the target storage compartment by the first position identifier.

Step S102: Collect a first image of the first position identifier by the visual component after controlling the robotic arm to move to the target photographing pose.

After the target photographing pose is acquired, a moving trajectory of the robotic arm may be planned according to the target photographing pose, where the planned moving trajectory includes position adjustment information of at least one driving joint of the robotic arm, so as to control the at least one driving joint of the robotic arm to move according to the respective planned position adjustment information, so that the robotic arm reaches the target photographing pose.

After the robotic arm moves to the target photographing pose, the visual component on the robotic arm is at an ideal target pose, and the first image of the first position identifier is collected by the visual component at the target pose.

Step S103: Control, according to the first image, the robotic arm to perform handover operation on the target goods by the end effector.

The handover operation may include operation of transferring the target goods from the end effector of the robotic arm to the target mounting mechanism, or operation of transferring the target goods from the target mounting mechanism to the end effector of the robotic arm.

By using the above method, the photographing pose of the robotic arm may be automatically calibrated according to the target handover position indicated by the handover instruction to obtain the target photographing pose. The robotic arm uses the target photographing pose calibrated in real time and collects the first image of the visual recognition beacon by the visual component. Compared with an image collected using a fixed photographing pose, the first image has higher accuracy for performing spatial visual positioning, so that the robotic arm can be controlled to perform handover operation more precisely, thereby improving the efficiency of completing the handover work.

FIG. 3 is a flowchart of a container control method according to the embodiment shown in FIG. 2. As shown in FIG. 3, step S101 includes the following sub-steps:

Step S1011: Acquire a preset photographing pose corresponding to the target handover position, where the preset photographing pose is a photographing pose of the robotic arm obtained through pre-calibration.

Step S1012: Collect a second image of the first position identifier by the visual component after controlling the robotic arm to move to the preset photographing pose.

In a possible application scenario, for each possible goods handover position corresponding to the container, a respective corresponding photographing pose of the robotic arm may be pre-calibrated. The possible goods handover position may include, for example, a position of a mounting mechanism in each storage compartment or a position of a mounting mechanism configured on the unmanned aerial vehicle. In this way, after the target handover position is acquired based on the handover instruction, the preset photographing pose of the robotic arm corresponding to the target handover position may be determined based on preset correspondence. The preset photographing pose may include a target movement position of at least one driving joint on the robotic arm. In this way, each driving joint of the at least one driving joint may be controlled to move to a respective corresponding target movement position, so that the robotic arm moves to the preset photographing pose.

After the robotic arm moves to the preset photographing pose, the visual component on the robotic arm may be controlled to collect the second image of the first position identifier.

Step S1013: Obtain the target photographing pose by recalibrating, according to the second image, the photographing pose of the robotic arm corresponding to target handover position.

In this step, a quality test result is obtained by performing a quality test on the second image, where the quality test result represents whether the second image includes the first position identifier, and/or a clarity level of the first position identifier The target photographing pose is obtained by recalibrating the photographing pose of the robotic arm corresponding to the target handover position in response to determining, according to the quality test result, that the second image does not include the first position identifier or the clarity level of the first position identifier is less than or equal to a preset clarity level threshold.

In an actual application scenario, the first position identifier (for example, the two-dimensional code) located at the target handover position may move, be blocked, or be partially damaged with the passage of time. In this case, if the second image is still collected according to the preset photographing pose calibrated in advance, spatial visual positioning may not be accurately performed on the target handover position based on the second image. Therefore, by performing this step, a quality test is performed on the second image, and after it is determined, according to the quality test result, that the second image does not include the first position identifier or only includes a part of the first position identifier. Alternatively, when the clarity level of the first position identifier in the second image is relatively low, the photographing pose of the robotic arm corresponding to the target handover position may be recalibrated to obtain the target photographing pose. Compared with the preset photographing pose, the photographing angle of the visual component for the first position identifier, and the relative position between the visual component and the first position identifier change at the target photographing pose. Therefore, the image of the first position identifier having the optimal quality at the current moment may be collected based on the target photographing pose, thereby improving the accuracy of spatial positioning.

In response to determining that the photographing pose of the robotic arm corresponding to the target handover position needs to be recalibrated, multiple preset photographing points corresponding to the target handover position may be acquired, and different preset photographing points represent different photographing poses of the robotic arm. A third image of the first position identifier collected by the visual component is acquired after controlling, for each preset photographing point, the robotic arm to move to the preset photographing point. The target photographing pose is obtained after performing hand-eye calibration according to the third image respectively corresponding to each preset photographing point.

The multiple photographing poses describes different positions and orientations of the robotic arm in a world coordinate system.

After the hand-eye calibration is performed according to the third image corresponding to each preset photographing point, the target photographing pose enabling optimal photographing quality can be obtained. Please refer to description in related literature for a specific step of performing the hand-eye calibration herein, which is not specifically limited herein.

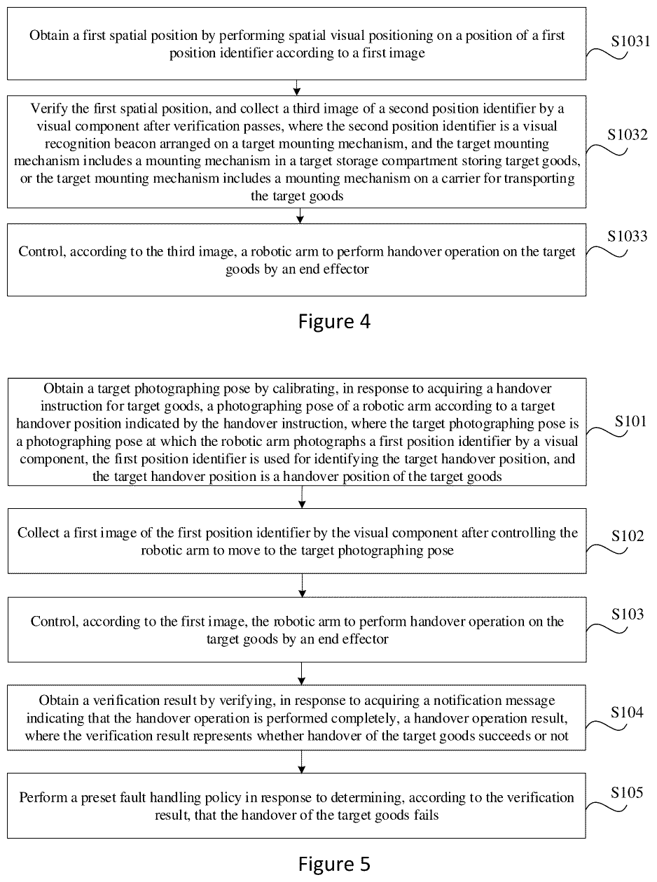

FIG. 4 is a flowchart of a container control method according to the embodiment shown in FIG. 2. As shown in FIG. 4, step S103 includes the following sub-steps:

Step S1031: Obtain a first spatial position by performing spatial visual positioning on a position of the first position identifier according to the first image.

The first position identifier may be, for example, a visual recognition beacon (which may be referred to as a “marker”, for example, a two-dimensional code) at the target storage compartment. In this step, the first spatial position identified by the first position identifier may be determined according to the first image based on a spatial visual positioning technology. When the first position identifier is a visual recognition beacon at the target storage compartment, the first spatial position represents a position of the target storage compartment.

Step S1032: Verify the first spatial position, and collect a third image of a second position identifier by the visual component after verification passes, where the second position identifier is a visual recognition beacon arranged on a target mounting mechanism, and the target mounting mechanism includes a mounting mechanism in the target storage compartment storing the target goods, or the target mounting mechanism includes a mounting mechanism on a carrier for transporting the target goods.

The carrier may be any one of various types of goods delivery devices such as an unmanned aerial vehicle, an unmanned vehicle, and a robot.

After obtaining the first spatial position, the visual component may send the first spatial position to the robotic arm, and the robotic arm verifies the first spatial position. The verification herein may include, for example, comparing the first spatial position with position information of the same position positioned at a historical moment, or comparing the first spatial position with a preset recorded position. If a distance difference between the two positions is less than or equal to a preset distance threshold (the preset distance threshold may be set according to control precision), it is determined that the verification on the first spatial position passes; otherwise, the verification fails.

In the present disclosure, the first position identifier is a marker located at the target storage compartment, and therefore, the first spatial position is a position of the target storage compartment. However, the handover operation is usually performed on the target goods between the end effector of the robotic arm and a target handling mechanism. Therefore, to accurately implement the handover operation on the target goods, a position of the target handling mechanism further needs to be accurately positioned. In an embodiment of the present disclosure, the process of obtaining the first spatial position by performing visual positioning based on the first image of the first position identifier may be considered as an initial positioning process. After initial positioning is successfully performed, fine positioning may be performed on the position of the target mounting mechanism based on the second position identifier to further determine the position of the target mounting mechanism. The second position identifier may include a visual recognition beacon located on the target mounting mechanism. The target mounting mechanism may include a mounting mechanism in the target storage compartment for storing the target goods, or may be a mounting mechanism on an unmanned aerial vehicle for transporting the target goods.

Step S1033: Control, according to the third image, the robotic arm to perform handover operation on the target goods by the end effector.

In this step, a second spatial position may be obtained by performing spatial visual positioning on the target handover position according to the third image. The second position identifier may be a visual recognition beacon located on the target mounting mechanism. Therefore, the second spatial position obtained by performing positioning based on the third image of the second position identifier is a position of the target mounting mechanism to participate in the handover operation. Then, a target moving trajectory may be obtained by performing trajectory planning according to the second spatial position. The robotic arm is controlled to move according to the target moving trajectory, so that the end effector moves to the second spatial position. In this way, after the end effector moves to the second spatial position, the handover operation may be accurately performed on the target goods by the end effector. The handover operation may include, for example, an action of mounting on the clamping jaw.

That the target moving trajectory is obtained by performing trajectory planning according to the second spatial position may include: obtaining a moving trajectory of each driving joint by planning a moving trajectory of each driving joint of the robotic arm with a target of moving the end effector of the robotic arm to the second spatial position; and then controlling, for each driving joint of the robotic arm, each driving joint of the robotic arm to move according to the moving trajectory corresponding to the driving joint, so as to move the end effector of the robotic arm to the second spatial position.

As described above, the handover instruction may include the first instruction or the second instruction. In a case that the handover instruction is the first instruction for mounting the target goods from the end effector to the target mounting mechanism, after the end effector moves to the second spatial position, the end effector may be controlled to transfer the target goods from the end effector to the target mounting mechanism.

For example, if the target goods are a takeout package, and the target mounting mechanism is the mounting mechanism in the target storage compartment, the takeout package may be placed in the target storage compartment of the container by transferring the takeout package from the end effector to the target mounting mechanism, so that the user can take food in the target storage compartment. When the target goods are a takeout package, and the target mounting mechanism is the mounting mechanism on the unmanned aerial vehicle, the takeout package may be mounted from the container to the unmanned aerial vehicle by transferring the takeout package from the end effector to the target mounting mechanism, so as to implement unmanned delivery of the takeout package by the unmanned aerial vehicle. This is merely an example herein, which is not limited in the present disclosure.

In a case that the handover instruction is the second instruction for transferring the target goods from the target mounting mechanism to the end effector, after the end effector moves to the second spatial position, the end effector may be controlled to transfer the target goods from the target mounting mechanism to the end effector.

For example, when the target goods are a takeout package, and the target mounting mechanism is the mounting mechanism in the target storage compartment, the takeout package may be transferred from the target storage compartment to another storage compartment (for example, transferred from the buffer compartment to the common compartment) by the robotic arm by transferring the takeout package from the target mounting mechanism to the end effector, or the takeout package may be transferred from the target storage compartment to the end effector of the robotic arm of the container by the robotic arm, so that the takeout package is delivered and mounted to the target mounting mechanism on the unmanned aerial vehicle by the robotic arm (thereby implementing delivery of the takeout package by the unmanned aerial vehicle). Alternatively, the takeout package mounted on the target mounting mechanism of the unmanned aerial vehicle may be transferred from the unmanned aerial vehicle to the end effector of the robotic arm of the container, so that the takeout package is stored to the container by the robotic arm. The examples herein are merely examples for description, which is not limited in the present disclosure.

FIG. 5 is a flowchart of a container control method according to the embodiment shown in FIG. 2. As shown in FIG. 5, after Steps S101-S103, the method further includes the following steps:

Step S104: Obtain a verification result by verifying, in response to acquiring a notification message indicating that the handover operation is performed completely, a handover operation result, where the verification result represents whether handover of the target goods succeeds or not.

In this step, a fourth image inside the target storage compartment is collected by the visual component, image recognition is performed on the fourth image, and the verification result is determined according to an image recognition result. Additionally or alternatively, a pressure signal collected by a pressure sensor is acquired, and the verification result is determined according to a change of the pressure signal within a preset time period, where the pressure sensor is deployed in the target storage compartment, or deployed on the end effector.

For example, it is assumed that the target goods are transferred from the target mounting mechanism in the target storage compartment to the end effector of the robotic arm by performing the handover operation. Image recognition may be performed on the fourth image. In response to determining, according to the image recognition result, that the target goods are no longer in the target storage compartment, and/or in response to determining, based on a signal change of the pressure sensor in the target storage compartment, that the target goods in the target storage compartment are moved out, it may be considered that the handover succeeds. Otherwise, it is determined that the handover operation fails.

In response to determining that the current target goods handover operation succeeds, the robotic arm may be controlled to move to a preset waiting position (which may be located in the container) to wait for next task scheduling.

Step S105: Perform a preset fault handling policy in response to determining, according to the verification result, that the handover of the target goods fails.

The preset fault processing policy may include, for example, controlling the visual component on the robotic arm to perform visual positioning again, so as to perform handover operation again based on the target handover position obtained through repositioning. Alternatively, a target terminal may be used to prompt for a fault (for example, output fault information), and the target terminal may include an operation and maintenance terminal bound to the container or the container itself. A feedback message indicating a goods handover failure may further be sent to the server.

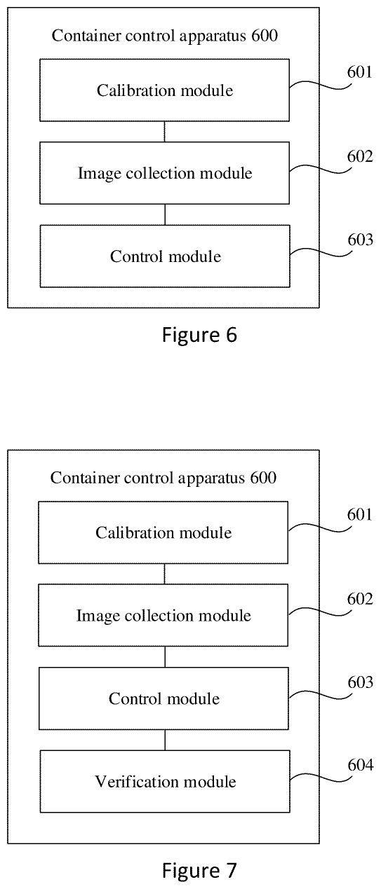

FIG. 6 is a block diagram of a container control apparatus 600 according to an example. A movable robotic arm is arranged in the container, and a visual component and an end effector located at an end of the robotic arm are arranged on the robotic arm. As shown in FIG. 6, the container control apparatus 600 includes:
a calibration module 601, configured to obtain a target photographing pose by calibrating, in response to acquiring a handover instruction for target goods, a photographing pose of the robotic arm according to a target handover position indicated by the handover instruction, where the target photographing pose is a photographing pose at which the robotic arm photographs a first position identifier by the visual component, the first position identifier is used for identifying the target handover position, and the target handover position is a handover position of the target goods;
an image collection module 602, configured to collect a first image of the first position identifier by the visual component after controlling the robotic arm to move to the target photographing pose; and
a control module 603, configured to control, according to the first image, the robotic arm to perform handover operation on the target goods by the end effector.

In some examples, the calibration module 601 is configured to acquire a preset photographing pose corresponding to the target handover position, where the preset photographing pose is a photographing pose of the robotic arm obtained through pre-calibration; collect a second image of the first position identifier by the visual component after controlling the robotic arm to move to the preset photographing pose; and obtain the target photographing pose by recalibrating, according to the second image, the photographing pose of the robotic arm corresponding to the target handover position.

In some examples, the calibration module 601 is configured to obtain a quality test result by performing a quality test on the second image, where the quality test result represents whether the second image includes the first position identifier, and/or a clarity level of the first position identifier; and obtain the target photographing pose by recalibrating the photographing pose of the robotic arm corresponding to the target handover position in response to determining, according to the quality test result, that the second image does not include the first position identifier or the clarity level of the first position identifier is less than or equal to a preset clarity level threshold.

In some examples, the calibration module 601 is configured to acquire multiple preset photographing points corresponding to the target handover position, where different preset photographing points represent different photographing poses of the robotic arm; acquire a third image of the first position identifier collected by the visual component after controlling, for each preset photographing point, the robotic arm to move to the preset photographing point; and obtain the target photographing pose after performing hand-eye calibration according to the third image respectively corresponding to each preset photographing point.

In some examples, the container includes multiple storage compartments, and a mounting mechanism for mounting goods is configured in each storage compartment;
the control module 603 is configured to obtain a first spatial position by performing spatial visual positioning on a position of the first position identifier according to the first image; verify the first spatial position, and collect a third image of a second position identifier by the visual component after verification passes, where the second position identifier is a visual recognition beacon arranged on a target mounting mechanism, and the target mounting mechanism includes a mounting mechanism in a target storage compartment storing the target goods, or the target mounting mechanism includes a mounting mechanism on an unmanned aerial vehicle for transporting the target goods; and control, according to the third image, the robotic arm to perform handover operation on the target goods by the end effector.

In some examples, the control module 603 is configured to obtain a second spatial position by performing spatial visual positioning on the target handover position according to the third image; obtain a target moving trajectory by performing trajectory planning according to the second spatial position; enable the end effector to move to the second spatial position by controlling the robotic arm to move according to the target moving trajectory; and perform handover operation on the target goods by the end effector after the end effector moves to the second spatial position.

In some examples, the handover instruction includes a first instruction for mounting the target goods from the end effector to the target mounting mechanism; and the control module 603 is configured to, in a case that the handover instruction is the first instruction, control the end effector to transfer the target goods from the end effector to the target mounting mechanism after the end effector moves to the second spatial position.

In some examples, the handover instruction includes a second instruction for transferring the target goods from the target mounting mechanism to the end effector; and the control module 603 is configured to, in a case that the handover instruction is the second instruction, control the end effector to transfer the target goods from the target mounting mechanism to the end effector after the end effector moves to the second spatial position.

In some examples, FIG. 7 is a block diagram of a container control apparatus 600 according to the embodiment shown in FIG. 6. As shown in FIG. 7, in addition to the calibration module 601, the image collection module 602, and the control module 603, the container control apparatus 600 further includes:
a verification module 604, configured to obtain a verification result by verifying a handover operation result in response to acquiring a notification message indicating that the handover operation is performed completely, where the verification result represents whether handover of the target goods succeeds or not; and perform a preset fault handling policy in response to determining, according to the verification result, that the handover of the target goods fails.

In some examples, the verification module 604 is configured to collect a fourth image inside the target storage compartment by the visual component, perform image recognition on the fourth image, and determine the verification result according to an image recognition result; and/or acquire a pressure signal collected by a pressure sensor, and determine the verification result according to a change of the pressure signal within a preset time period, where the pressure sensor is deployed in the target storage compartment, or deployed on the end effector.

Specific manners of performing operations by the modules in the apparatuses in the above embodiments have been described in detail in the embodiments related to the method, and will not be described in detail herein.

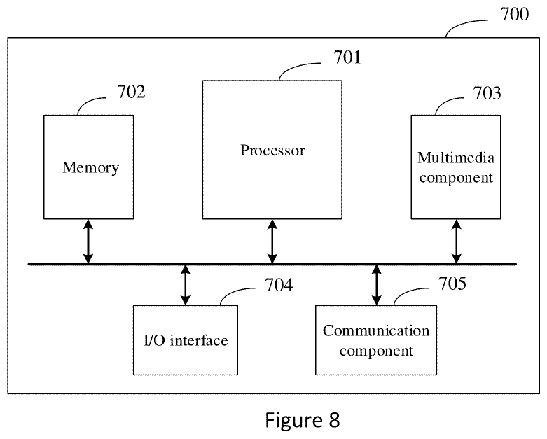

FIG. 8 is a block diagram of an electronic device 700 according to an example. As shown in FIG. 8, the electronic device 700 may include: a processor 701 and a memory 702. The electronic device 700 may further include one or more of a multimedia component 703, an input/output (I/O) interface 704, and a communication component 705.

The processor 701 is configured to control overall operation of the electronic device 700, to complete all or some steps of the above container control method. The memory 702 is configured to store various types of data to support operation on the electronic device 700. The data may include, for example, an instruction of any application program or method used for operation on the electronic device 700, and data related to an application program, for example, contact data, a received and sent message, a picture, audio, and a video. The memory 702 may be implemented by any type of volatile or non-volatile storage device or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or an optical disc. The multimedia component 703 may include a screen and an audio component. The screen may be, for example, a touchscreen, and the audio component is configured to output and/or input an audio signal. For example, the audio component may include a microphone, and the microphone is configured to receive an external audio signal. The received audio signal may be further stored in the memory 702 or sent by the communication component 705. The audio component further includes at least one speaker, configured to output the audio signal. The I/O interface 704 provides an interface between the processor 701 and another interface module. The above another interface module may be a keyboard, a mouse, buttons, or the like. The buttons may be virtual buttons or physical buttons. The communication component 705 is configured to perform wired or wireless communication between the electronic device 700 and another device. The wireless communication may be, for example, Wi-Fi, Bluetooth, Near Field Communication (NFC), 2G, 3G, 4G, NB-IoT, eMTC, or other 5G, or a combination of one or more of them, which is not limited herein. Therefore, the corresponding communication component 705 may include: a Wi-Fi module, a Bluetooth module, an NFC module, and the like.

In an example, the electronic device 700 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors, or other electronic elements, and configured to perform the above container control method.

In another example, a non-transitory computer-readable storage medium including program instructions is further provided, where the program instructions, when executed by one or more processors, implement steps of the above container control method. For example, the non-transitory computer-readable storage medium may be the above memory 702 including program instructions, and the above program instructions may be executed by the processor 701 of the electronic device 700 to implement steps of the above container control method.

In another example, a computer program product is further provided. The computer program product includes a computer program that can be executed by a programmable apparatus, and when executed by the programmable apparatus, the computer program has a code part used for performing the above container control method.

Although optional embodiments of the present disclosure have been described in detail with reference to the accompanying drawings, the present disclosure is not limited to the details in the embodiments described above, various simple modifications may be made within the technical conception and scope of the present disclosure, and these simple modifications are all within the protection scope of the present disclosure.

As used herein, the term “processor” may refer to one processor that performs the defined functions or a plurality of processors that collectively perform defined functions, such that the execution of the individual defined functions may be divided amongst such processors.

It is to be additionally noted that the various specific technical features described in the above specific embodiments may be combined in any suitable manner without contradiction, and in order to avoid unnecessary repetition, the present disclosure does not separately describe the various possible combinations.

In addition, different embodiments of the present disclosure may also be arbitrarily combined without departing from the idea of the present disclosure, and these combinations are still regarded as content disclosed in the present disclosure.

Additional non-limiting embodiments of the disclosure include the following.

According to a first aspect, the present disclosure provides a container control method, where the container includes a movable robotic arm, and a visual component and an end effector located at an end of the robotic arm are arranged on the robotic arm. The method includes:
obtaining a target photographing pose by calibrating, in response to acquiring a handover instruction for target goods, a photographing pose of the robotic arm according to a target handover position indicated by the handover instruction, where the target photographing pose is a photographing pose at which the robotic arm photographs a first position identifier by the visual component, the first position identifier is used for identifying the target handover position, and the target handover position is a handover position of the target goods;
collecting a first image of the first position identifier by the visual component after controlling the robotic arm to move to the target photographing pose; and
controlling, according to the first image, the robotic arm to perform handover operation on the target goods by the end effector.

Optionally, the obtaining a target photographing pose by calibrating a photographing pose of the robotic arm according to a target handover position indicated by the handover instruction includes:
acquiring a preset photographing pose corresponding to the target handover position, where the preset photographing pose is a photographing pose of the robotic arm obtained through pre-calibration;
collecting a second image of the first position identifier by the visual component after controlling the robotic arm to move to the preset photographing pose; and
obtaining the target photographing pose by recalibrating, according to the second image, the photographing pose of the robotic arm corresponding to the target handover position.

Optionally, the obtaining the target photographing pose by recalibrating, according to the second image, the photographing pose of the robotic arm corresponding to the target handover position includes:
obtaining a quality test result by performing a quality test on the second image, where the quality test result represents whether the second image includes the first position identifier, and/or a clarity level of the first position identifier; and
obtaining the target photographing pose by recalibrating the photographing pose of the robotic arm corresponding to the target handover position in response to determining, according to the quality test result, that the second image does not include the first position identifier or the clarity level of the first position identifier is less than or equal to a preset clarity level threshold.

Optionally, the obtaining the target photographing pose by recalibrating the photographing pose of the robotic arm corresponding to the target handover position includes:
acquiring multiple preset photographing points corresponding to the target handover position, where different preset photographing points represent different photographing poses of the robotic arm;
acquiring a third image of the first position identifier collected by the visual component after controlling, for each preset photographing point, the robotic arm to move to the preset photographing point; and
obtaining the target photographing pose after performing hand-eye calibration according to the third image respectively corresponding to each preset photographing point.

Optionally, the container includes multiple storage compartments, and a mounting mechanism for mounting goods is configured in each storage compartment;
the controlling, according to the first image, the robotic arm to perform handover operation on the target goods by the end effector includes:
obtaining a first spatial position by performing spatial visual positioning on a position of the first position identifier according to the first image;
verifying the first spatial position, and collecting a third image of a second position identifier by the visual component after verification passes, where the second position identifier is a visual recognition beacon arranged on a target mounting mechanism, and the target mounting mechanism includes a mounting mechanism in a target storage compartment storing the target goods, or the target mounting mechanism includes a mounting mechanism on a carrier for transporting the target goods; and
controlling, according to the third image, the robotic arm to perform handover operation on the target goods by the end effector.

Optionally, the carrier may be an unmanned aerial vehicle, an unmanned vehicle, or a robot.

Optionally, the controlling, according to the third image, the robotic arm to perform handover operation on the target goods by the end effector includes:
obtaining a second spatial position by performing spatial visual positioning on the target handover position according to the third image;
obtaining a target moving trajectory by performing trajectory planning according to the second spatial position;
enabling the end effector to move to the second spatial position by controlling the robotic arm to move according to the target moving trajectory; and
performing handover operation on the target goods by the end effector after the end effector moves to the second spatial position.

Optionally, the handover instruction includes a first instruction for mounting the target goods from the end effector to the target mounting mechanism; and
the performing handover operation on the target goods by the end effector after the end effector moves to the second spatial position includes:
in a case that the handover instruction is the first instruction, controlling the end effector to transfer the target goods from the end effector to the target mounting mechanism after the end effector moves to the second spatial position;
or, the handover instruction includes a second instruction for transferring the target goods from the target mounting mechanism to the end effector; and
the performing handover operation on the target goods by the end effector after the end effector moves to the second spatial position includes:
in a case that the handover instruction is the second instruction, controlling the end effector to transfer the target goods from the target mounting mechanism to the end effector after the end effector moves to the second spatial position.

Optionally, the method further includes:
obtaining a verification result by verifying, in response to acquiring a notification message indicating that the handover operation is performed completely, a handover operation result, where the verification result represents whether handover of the target goods succeeds or not; and
performing a preset fault handling policy in response to determining, according to the verification result, that the handover of the target goods fails.

Optionally, the obtaining a verification result by verifying a handover operation result includes:
collecting a fourth image inside the target storage compartment by the visual component, performing image recognition on the fourth image, and determining the verification result according to an image recognition result; and/or
acquiring a pressure signal collected by a pressure sensor, and determining the verification result according to a change of the pressure signal within a preset time period, where the pressure sensor is deployed in the target storage compartment, or deployed on the end effector.

According to a second aspect, the present disclosure provides a container control apparatus, where a movable robotic arm is arranged in the container, and a visual component and an end effector located at an end of the robotic arm are arranged on the robotic arm. The apparatus includes:
a calibration module, configured to obtain a target photographing pose by calibrating, in response to acquiring a handover instruction for target goods, a photographing pose of the robotic arm according to a target handover position indicated by the handover instruction, where the target photographing pose is a photographing pose at which the robotic arm photographs a first position identifier by the visual component, the first position identifier is used for identifying the target handover position, and the target handover position is a handover position of the target goods;
an image collection module, configured to collect a first image of the first position identifier by the visual component after controlling the robotic arm to move to the target photographing pose; and
a control module, configured to control, according to the first image, the robotic arm to perform handover operation on the target goods by the end effector.

According to a third aspect, the present disclosure provides a computer-readable storage medium, having a computer program stored therein, where the computer program, when executed by a processor, implements steps of the container control method described in the first aspect of the present disclosure.

According to a fourth aspect, the present disclosure provides an electronic device, including:
a memory, having a computer program stored therein; and
a processor, configured to execute the computer program in the memory, to implement steps of the container control method described in the first aspect of the present disclosure.

According to a fifth aspect, the present disclosure provides a computer program product, including a computer program, where the computer program, when executed by a processor, implements steps of the container control method described in the first aspect of the present disclosure.

Through the above technical solution, the photographing pose of the robotic arm may be automatically calibrated according to the target handover position indicated by the handover instruction, so that the target photographing pose is obtained. The robotic arm uses the target photographing pose which is automatically calibrated in real time to collect, by the visual component, the first image of the visual recognition beacon. Compared with an image collected by using a fixed photographing pose, the first image has higher accuracy for performing spatial visual positioning, so that the robotic arm can be controlled to perform handover operation more precisely, thereby improving the efficiency of completing handover work.

1. A container control method, wherein a movable robotic arm is arranged in the container, and a visual component and an end effector located at an end of the robotic arm are arranged on the robotic arm; the method comprises:
obtaining a target photographing pose by calibrating, in response to acquiring a handover instruction for target goods, a photographing pose of the robotic arm according to a target handover position indicated by the handover instruction, wherein the target photographing pose is a photographing pose at which the robotic arm photographs a first position identifier by the visual component, the first position identifier is used for identifying the target handover position, and the target handover position is a handover position of the target goods;
collecting a first image of the first position identifier by the visual component after controlling the robotic arm to move to the target photographing pose; and
controlling, according to the first image, the robotic arm to perform handover operation on the target goods by the end effector.

2. The method according to claim 1, wherein the obtaining a target photographing pose by calibrating a photographing pose of the robotic arm according to a target handover position indicated by the handover instruction comprises:
acquiring a preset photographing pose corresponding to the target handover position, wherein the preset photographing pose is a photographing pose of the robotic arm obtained through pre-calibration;
collecting a second image of the first position identifier by the visual component after controlling the robotic arm to move to the preset photographing pose; and
obtaining the target photographing pose by recalibrating, according to the second image, the photographing pose of the robotic arm corresponding to the target handover position.

3. The method according to claim 2, wherein the obtaining the target photographing pose by recalibrating, according to the second image, the photographing pose of the robotic arm corresponding to the target handover position comprises:
obtaining a quality test result by performing a quality test on the second image, wherein the quality test result represents whether the second image comprises the first position identifier, and/or a clarity level of the first position identifier; and
obtaining the target photographing pose by recalibrating the photographing pose of the robotic arm corresponding to the target handover position in response to determining, according to the quality test result, that the second image does not comprise the first position identifier or the clarity level of the first position identifier is less than or equal to a preset clarity level threshold.

4. The method according to claim 3, wherein the obtaining the target photographing pose by recalibrating the photographing pose of the robotic arm corresponding to the target handover position comprises:
acquiring a plurality of preset photographing points corresponding to the target handover position, wherein different preset photographing points represent different photographing poses of the robotic arm;
acquiring a third image of the first position identifier collected by the visual component after controlling, for each preset photographing point, the robotic arm to move to the preset photographing point; and
obtaining the target photographing pose after performing hand-eye calibration according to the third image respectively corresponding to each preset photographing point.

5. The method according to claim 1, wherein the container comprises a plurality of storage compartments, and a mounting mechanism for mounting goods is configured in each storage compartment;
the controlling, according to the first image, the robotic arm to perform handover operation on the target goods by the end effector comprises:
obtaining a first spatial position by performing spatial visual positioning on a position of the first position identifier according to the first image;
verifying the first spatial position, and collecting a third image of a second position identifier by the visual component after verification passes, wherein the second position identifier is a visual recognition beacon arranged on a target mounting mechanism, and the target mounting mechanism comprises a mounting mechanism in a target storage compartment storing the target goods, or the target mounting mechanism comprises a mounting mechanism on a carrier for transporting the target goods; and
controlling, according to the third image, the robotic arm to perform handover operation on the target goods by the end effector.

6. The method according to claim 5, wherein the controlling, according to the third image, the robotic arm to perform handover operation on the target goods by the end effector comprises:
obtaining a second spatial position by performing spatial visual positioning on the target handover position according to the third image;
obtaining a target moving trajectory by performing trajectory planning according to the second spatial position;
enabling the end effector to move to the second spatial position by controlling the robotic arm to move according to the target moving trajectory; and
performing handover operation on the target goods by the end effector after the end effector moves to the second spatial position.

7. The method according to claim 6, wherein the handover instruction comprises a first instruction for mounting the target goods from the end effector to the target mounting mechanism; and
the performing handover operation on the target goods by the end effector after the end effector moves to the second spatial position comprises:
in a case that the handover instruction is the first instruction, controlling the end effector to transfer the target goods from the end effector to the target mounting mechanism after the end effector moves to the second spatial position;
or,
the handover instruction comprises a second instruction for transferring the target goods from the target mounting mechanism to the end effector; and
the performing handover operation on the target goods by the end effector after the end effector moves to the second spatial position comprises:
in a case that the handover instruction is the second instruction, controlling the end effector to transfer the target goods from the target mounting mechanism to the end effector after the end effector moves to the second spatial position.

8. The method according to claim 5, further comprising:
obtaining a verification result by verifying, in response to acquiring a notification message indicating that the handover operation is performed completely, a handover operation result, wherein the verification result represents whether handover of the target goods succeeds or not; and
performing a preset fault handling policy in response to determining, according to the verification result, that the handover of the target goods fails.

9. The method according to claim 8, wherein the obtaining a verification result by verifying a handover operation result comprises:
collecting a fourth image inside the target storage compartment by the visual component, performing image recognition on the fourth image, and determining the verification result according to an image recognition result; and/or
acquiring a pressure signal collected by a pressure sensor, and determining the verification result according to a change of the pressure signal within a preset time period, wherein the pressure sensor is deployed in the target storage compartment, or deployed on the end effector.

10. The method according to claim 5, wherein the carrier is an unmanned aerial vehicle, an unmanned vehicle, or a robot.

11. An electronic device, comprising:
a memory having a computer program stored therein; and
one or more processors collectively configured to execute the computer program in the memory to cause the electronic device to:
obtain a target photographing pose by calibrating, in response to acquiring a handover instruction for target goods, a photographing pose of a movable robotic arm arranged in a container according to a target handover position indicated by the handover instruction, wherein the target photographing pose is a photographing pose at which the robotic arm photographs a first position identifier by a visual component arranged on the robotic arm, the first position identifier is used for identifying the target handover position, and the target handover position is a handover position of the target goods;
collect a first image of the first position identifier by the visual component after controlling the robotic arm to move to the target photographing pose; and
control, according to the first image, the robotic arm to perform handover operation on the target goods by an end effector located at an end of the robotic arm.

12. The electronic device according to claim 11, wherein the one or more processors are further collectively configured to execute the computer program to cause the electronic device to:
acquire a preset photographing pose corresponding to the target handover position, wherein the preset photographing pose is a photographing pose of the robotic arm obtained through pre-calibration;
collect a second image of the first position identifier by the visual component after controlling the robotic arm to move to the preset photographing pose; and
obtain the target photographing pose by recalibrating, according to the second image, the photographing pose of the robotic arm corresponding to the target handover position.

13. The electronic device according to claim 12, wherein the one or more processors are further collectively configured to execute the computer program to cause the electronic device to:
obtain a quality test result by performing a quality test on the second image, wherein the quality test result represents whether the second image comprises the first position identifier, and/or a clarity level of the first position identifier; and
obtain the target photographing pose by recalibrating the photographing pose of the robotic arm corresponding to the target handover position in response to determining, according to the quality test result, that the second image does not comprise the first position identifier or the clarity level of the first position identifier is less than or equal to a preset clarity level threshold.

14. The electronic device according to claim 13, wherein the one or more processors are further collectively configured to execute the computer program to cause the electronic device to:
acquire a plurality of preset photographing points corresponding to the target handover position, wherein different preset photographing points represent different photographing poses of the robotic arm;
acquire a third image of the first position identifier collected by the visual component after controlling, for each preset photographing point, the robotic arm to move to the preset photographing point; and
obtain the target photographing pose after performing hand-eye calibration according to the third image respectively corresponding to each preset photographing point.

15. The electronic device according to claim 11, wherein the container comprises a plurality of storage compartments, and a mounting mechanism for mounting goods is configured in each storage compartment; and
the one or more processors are further collectively configured to execute the computer program to cause the electronic device to:
obtain a first spatial position by performing spatial visual positioning on a position of the first position identifier according to the first image;
verify the first spatial position, and collect a third image of a second position identifier by the visual component after verification passes, wherein the second position identifier is a visual recognition beacon arranged on a target mounting mechanism, and the target mounting mechanism comprises a mounting mechanism in a target storage compartment storing the target goods, or the target mounting mechanism comprises a mounting mechanism on a carrier for transporting the target goods; and
control, according to the third image, the robotic arm to perform handover operation on the target goods by the end effector.

16. The electronic device according to claim 15, wherein the one or more processors are further collectively configured to execute the computer program to cause the electronic device to:
obtain a second spatial position by performing spatial visual positioning on the target handover position according to the third image;
obtain a target moving trajectory by performing trajectory planning according to the second spatial position;
enable the end effector to move to the second spatial position by controlling the robotic arm to move according to the target moving trajectory; and
perform handover operation on the target goods by the end effector after the end effector moves to the second spatial position.

17. The electronic device according to claim 16, wherein the handover instruction comprises a first instruction for mounting the target goods from the end effector to the target mounting mechanism; and
the one or more processors are further collectively configured to execute the computer program to cause the electronic device to:
in a case that the handover instruction is the first instruction, control the end effector to transfer the target goods from the end effector to the target mounting mechanism after the end effector moves to the second spatial position;
or,
the handover instruction comprises a second instruction for transferring the target goods from the target mounting mechanism to the end effector; and
the one or more processors are further collectively configured to execute the computer program to cause the electronic device to:
in a case that the handover instruction is the second instruction, control the end effector to transfer the target goods from the target mounting mechanism to the end effector after the end effector moves to the second spatial position.

18. The electronic device according to claim 15, wherein the one or more processors are further collectively configured to execute the computer program to cause the electronic device to:
obtain a verification result by verifying, in response to acquiring a notification message indicating that the handover operation is performed completely, a handover operation result, wherein the verification result represents whether handover of the target goods succeeds or not; and
perform a preset fault handling policy in response to determining, according to the verification result, that the handover of the target goods fails.

19. The electronic device according to claim 18, wherein the one or more processors are further collectively configured to execute the computer program to cause the electronic device to:
collect a fourth image inside the target storage compartment by the visual component, perform image recognition on the fourth image, and determine the verification result according to an image recognition result; and/or
acquire a pressure signal collected by a pressure sensor, and determine the verification result according to a change of the pressure signal within a preset time period, wherein the pressure sensor is deployed in the target storage compartment, or deployed on the end effector.

20. A non-transitory computer-readable storage medium, configured to store a computer program, wherein the computer program, when executed by one or more processors of an electronic device, causes the electronic device to:
obtain a target photographing pose by calibrating, in response to acquiring a handover instruction for target goods, a photographing pose of a movable robotic arm arranged in a container according to a target handover position indicated by the handover instruction, wherein the target photographing pose is a photographing pose at which the robotic arm photographs a first position identifier by a visual component arranged on the robotic arm, the first position identifier is used for identifying the target handover position, and the target handover position is a handover position of the target goods;
collect a first image of the first position identifier by the visual component after controlling the robotic arm to move to the target photographing pose; and
control, according to the first image, the robotic arm to perform handover operation on the target goods by an end effector located at an end of the robotic arm.
